(19) United States
(12) Patent Application Publication
(10) Pub. No.: US 2020/0125323 A1
(43) Pub. Date: Apr. 23, 2020

(54) DISPLAY DEVICE AND CONTROL METHOD THEREOF

(71) Applicant: SAMSUNG ELECTRONICS CO., LTD., Suwon-si (KR)

(72) Inventors: Sang Min LEE, Suwon-si (KR); Geum Rae BAE, Suwon-si (KR)

(73) Assignee: SAMSUNG ELECTRONICS CO., LTD., Suwon-si (KR)

(21) Appl. No.: 16/656,723

(22) Filed: Oct. 18, 2019

(30) Foreign Application Priority Data
Oct. 18, 2018 (KR) 10-2018-0124671
Jul. 10, 2019 (KR) 10-2019-0083339

(51) Int. Cl. G06F 3/16; G09G 5/12

(52) U.S. Cl. CPC G06F 3/167; G06F 3/165; G09G 5/12

(57) ABSTRACT

A display device and control method thereof, for controlling output of a sound signal corresponding to an image by controlling output of the image without an extra control operation by determining whether to suspend a sound signal based on deactivating an image corresponding to the sound signal.

### CROSS-REFERENCE TO RELATED APPLICATION

This application is based on and claims priority under 35 U.S.C. § 119 to Korean Patent Application Nos. 10-2018-0124671 filed on Oct. 18, 2018, and 10-2019-0083339 filed on Jul. 10, 2019, filed in the Korean Intellectual Property Office, the disclosures of which are herein incorporated by reference in their entireties.

### BACKGROUND

### 1. Field

The disclosure relates to a display device and control method thereof, and more particularly, to a display device and control method thereof for providing interactive board functions.

### 2. Discussion of Related Art

Display devices used in conference rooms may include a remote control function.

Remote control refers to a function of software or an operating system to execute a program of an external device as if the program is running in a device that is remotely controlling the external device.

Using the remote control, the user may use a display device in a conference room to access an external device at a remote place to use a resource of the external device.

Once connected to the external device at the remote location using the remote control function of the display device, the user may reproduce multimedia content.

For example, to control sound being reproduced with the remote control function, the user executes the remote control function to control an audio player program of the external device or control an audio system of the display device.

Such remote control may discontinue the ongoing conference in a conference-oriented environment, causing inconvenience to the user. Hence, there is a need for studies on devices for providing various services while maintaining continuity in conference.

### SUMMARY

The disclosure provides a display device and control method thereof, for controlling output of a sound signal corresponding to an image by controlling output of the image without an extra control operation.

According to an embodiment, there is provided a display device including a communication interface configured to receive, from an external device, video data of video information displayed on the external device and audio data corresponding to the video data, a speaker, a display, an input interface configured to receive user input of a user of the display device, and a controller configured to control the display to display the video information, based on the video data, control the speaker to output audio, based on the audio data, control the input interface to receive the user input to deactivate displaying of the video information, and control the speaker to suspend the audio, based on the user input to deactivate the displaying of the video information.

According to an embodiment, there is provided a method of controlling a display device, the method including receiving, from an external device, video data of video information displayed on the external device and audio data corresponding to the video data, controlling a display of the display device to display the video information, based on the video data, controlling a speaker of the display device to output audio, based on the audio data, receiving user input to deactivate displaying of the video information, and controlling the speaker to suspend the audio, based on the user input to deactivate the displaying of the video information.

### BRIEF DESCRIPTION OF THE DRAWINGS

The above and other objects, features and advantages of the disclosure will become more apparent to those of ordinary skill in the art by describing in detail exemplary embodiments thereof with reference to the accompanying drawings, in which:

FIG. 1 is an exterior view of a display device, according to an embodiment of the disclosure;

FIG. 2 is a control block diagram of a display device, according to an embodiment of the disclosure;

FIG. 3 is a diagram illustrating a relationship between a display device and external devices, according to an embodiment of the disclosure;

FIG. 4 is a diagram illustrating the output of a sound signal corresponding to an image of at least one area, according to an embodiment of the disclosure;

FIG. 5 is a diagram for explaining an operation to stop outputting sound based on an image minimization command, according to an embodiment of the disclosure;

FIG. 6 is a diagram for explaining an operation to stop outputting sound by closing an image, according to an embodiment of the disclosure;

FIGS. 7 and 8 are diagrams for explaining an operation to set priorities among applications, according to an embodiment of the disclosure;

FIGS. 9 and 10 are diagrams for explaining an operation performed when a display device is connected to a plurality of external devices, according to an embodiment of the disclosure; and

FIG. 11 is a diagram for explaining a display device performing an authentication procedure and controlling an external device, according to an embodiment of the disclosure;

FIG. 12 is a diagram for explaining a display device performing an operation based on a voice command;

FIG. 13 is a flowchart of a method of controlling a display apparatus, according to an embodiment of the disclosure;

FIG. 14 is a flowchart of a method of controlling a display apparatus, according to an embodiment of the disclosure;

FIG. 15 is a flowchart of a method of controlling a display apparatus, according to an embodiment of the disclosure;

FIG. 16 is a flowchart of a method of controlling a display apparatus, according to an embodiment of the disclosure; and

FIG. 17 is a flowchart of a method of controlling a display apparatus, according to an embodiment of the disclosure.

### DETAILED DESCRIPTION OF EXEMPLARY EMBODIMENTS

Like numerals refer to like elements throughout the specification. Not all elements of embodiments of the disclosure will be described, and description of what are commonly known in the art or what overlap each other in the embodiments will be omitted. The terms as used throughout the specification, such as “˜ part”, “˜ module”, “˜ member”, “˜ block”, etc., may be implemented in software and/or hardware, and a plurality of “˜ parts”, “˜ modules”, “˜ members”, or “˜ blocks” may be implemented in a single element, or a single “˜ part”, “˜ module”, “˜ member”, or “˜ block” may include a plurality of elements.

It will be further understood that the term “connect” or its derivatives refer both to direct and indirect connection, and the indirect connection includes a connection over a wireless communication network.

The term “include (or including)” or “comprise (or comprising)” is inclusive or open-ended and does not exclude additional, unrecited elements or method steps, unless otherwise mentioned.

Throughout the specification, when it is said that a member is located “on” another member, it implies not only that the member is located adjacent to the other member but also that a third member exists between the two members.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section.

It is to be understood that the singular forms “a,” “an,” and “the” include plural references unless the context clearly dictates otherwise.

Reference numerals used for method steps are just used for convenience of explanation, but not to limit an order of the steps. Thus, unless the context clearly dictates otherwise, the written order may be practiced otherwise.

The principle and embodiments of the disclosure will now be described with reference to accompanying drawings.

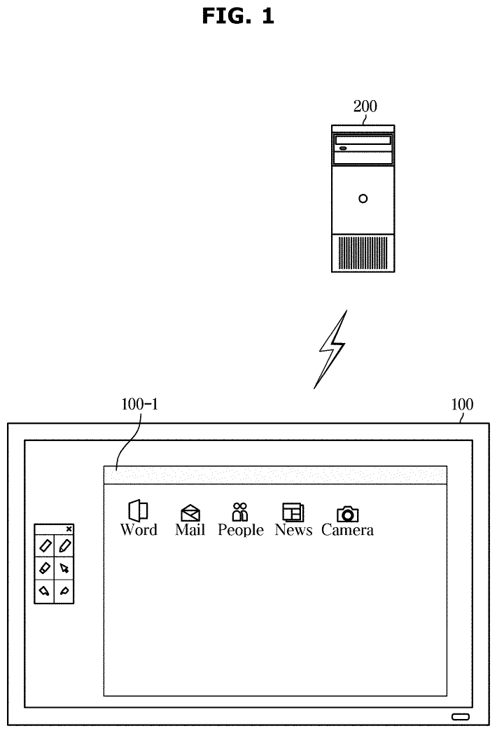

FIG. 1 illustrates a display device 100 and an external device 200, according to an embodiment of the disclosure.

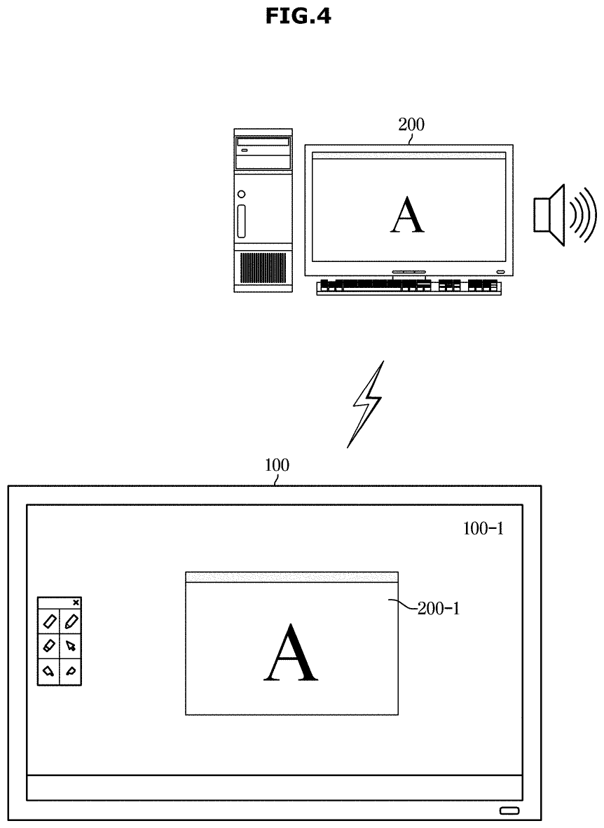

Referring to FIG. 1, the display device 100 may communicate with at least one external device 200. The external device 200 may be implemented by various types of electronic devices such as a desktop personal computer (PC), a set top box, a smart phone, a tablet, etc. The display device 100 may be controlled to display a screen 200-1 corresponding to the external device 200 (see FIG. 4). For example, while in communication with a PC, the display device 100 may display a screen received from the PC.

The display device 100 may also display a screen 100-1 that is generated by the display device 100 itself. The screen 100-1 corresponding to the display device 100 may be a screen for executing the display device's 100 own functions and/or applications.

For example, when the display device 100 is implemented as an interactive board, the display device 100 may display a screen that provides an interactive board function. The interactive board function may provide a black or white screen function mimicking the functionality of a conventional blackboard and a writing function. The screen is not, however, limited thereto, and a screen for executing any function that is performed in an ordinary interactive board may be displayed.

Furthermore, as shown in FIG. 4, the display device 100 may display both the screen corresponding to the display device 100 and the screen corresponding to the external device 200 at the same time. Specifically, the display device 100 may display the screen corresponding to the display device 100 in some display area and the screen corresponding to the external device 200 in the other display area. The display device 100 is not, however, limited thereto, and the display device 100 may display just one screen corresponding to the external device 200 or the display device 100.

Furthermore, the display device 100 may include a sensor for detecting touches, for example according to a touch received on a touch screen display. When detecting a touch, the sensor may send information corresponding to the touch to an external device or the display device based on the touch type. The touch type will be described later in detail.

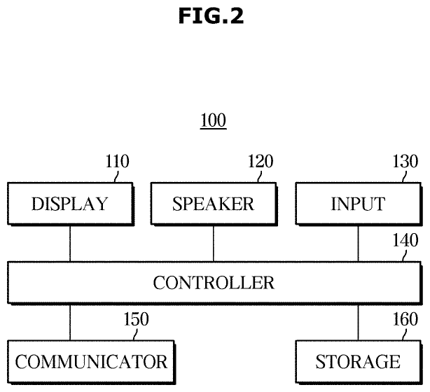

FIG. 2 is a block diagram of the display device 100, according to an embodiment of the disclosure.

Referring to FIG. 2, the display device 100 may include a display 110, a speaker 120, an input 130, a communicator 150, a storage 160, and a controller 140.

The display device 100 may be implemented with various types of electronic devices such as a television, an interactive board, an electronic table, a large format display (LFD), etc. The interactive board may refer to an electronic device equipped with a touch screen panel implemented in e.g., an infrared touch screen type using an infrared (IR) sensor, a surface acoustic wave touch screen type, a resistive touch screen type, a capacitive touch screen type, etc., to allow writing thereon with an electronic pen or the finger of the user. The display device 100 is not, however, limited thereto, and the interactive board may also be implemented in a way of identifying a touch area using e.g., a camera.

Furthermore, in an embodiment, the display device 100 may be implemented as the interactive board and also as a television, electronic table, or LFD capable of performing the interactive board function.

The display 110 may display at least one of the screen of the display device 100 itself and a screen received from an external device.

Furthermore, the display 110 may display various contents, such as all kinds of moving images created as a plurality of images, such as a film, a soap opera, a recorded image, a slow video, etc., and displayed with certain frame ratios, still images, photos, documents, etc.

The display 110 may also display a user interface screen including many different menus provided by applications or an operating system of the display device 100. The user interface screen may include various menus to control operations of the display device 100, e.g., volume up/down menus, channel up/down menus, setting menus, etc.

Especially, the display 110 may display a screen that provides the interactive board function. The screen that provides the interactive board function may be displayed with a black or white background image. The background image may be provided as a transparent screen with adjusted transparency. The interactive board function refers to all functions that may be performed in an interactive board device.

The display 110 may be implemented with any display panel such as a liquid crystal display (LCD), organic light emitting diodes (OLEDs), a plasma display panel (PDP), or the like.

The speaker 120 may be implemented for outputting sound. The speaker 120 may output a sound signal corresponding to an image, as will be described later. The speaker 120 may output a sound signal of the display device 100 or of an external device remotely coupled to the display device 100.

The input 130 may be an interface implemented to receive a command of the user. Specifically, the input 130 may include an interface for receiving signals from a remote controller, an interface for receiving input via a touch panel, a mechanical button mounted on the display device 100, a keyboard, a mouse, etc.

When the display 110 is touch-sensitive, the input 130 may detect a touch against the display 110. Specifically, the input 130 may include various types of sensors. For example, the input 130 may be implemented as a touch sensor to recognize touches, a motion sensor to detect motion of the user, or a sensor to detect movements and trajectories of an electronic pen.

The user may activate or deactivate a portion of an image reproduced on the display 110 through the input 130. The user may change priority of an image of at least one area output on the display 110 through the input 130. The user may deactivate an image by entering a command to minimize an image of at least one area output on the display 110 through the input 130.

The communicator 150 may be a communication interface configured to perform communication with at least one external device. Specifically, the display device 100 may be wired or wirelessly connected to an external device through the communicator 150. The communicator 150 may then transmit to or receive data from the external device via a universal serial bus (USB), a serial port, Wireless Fidelity (Wi-Fi), Bluetooth, etc. The supported standard is not limited thereto, and other standards may also be supported. Accordingly, the display device 100 may use the communicator 150 to receive data and display a screen corresponding to the connected external device.

The communicator 150 may include one or more components that enable communication with an external device, for example, at least one of a short-range communication module, a wired communication module, and a wireless communication module.

The short-range communication module may include various short range communication modules for transmitting and receiving signals within a short range over a wireless communication network, such as Bluetooth module, an infrared communication module, a radio frequency identification (RFID) communication module, a wireless local access network (WLAN) communication module, a near field communication (NFC) module, a Zigbee communication module, etc.

The wired communication module may include not only one of various wired communication modules, such as a network interface controller (NIC) for communicating over a network such as the Internet, a controller area network (CAN) communication module, a local area network (LAN) module, a wide area network (WAN) module, or a value added network (VAN) module, but also one of various cable communication modules, such as a universal serial bus (USB), a high definition multimedia interface (HDMI), a digital visual interface (DVI), recommended standard (RS) 232, a power cable, or a plain old telephone service (POTS).

The wireless communication module may include a wireless fidelity (WiFi) module, a wireless broadband (Wibro) module, and/or any wireless communication device for supporting various wireless communication schemes, such as a global system for mobile communication (GSM) module, a code division multiple access (CDMA) module, a wideband code division multiple access (WCDMA) module, a universal mobile telecommunications system (UMTS), a time division multiple access (TDMA) module, a long term evolution (LTE) module, etc.

The storage 160 may be memory that stores various data, programs, or applications for driving and controlling the display device 100.

The storage 160 may store a control program to control the display device 100 when the control program is executed by a processor such as the controller 140, an application provided by a manufacturer by default or downloaded from an external source, a graphical user interface (GUI) related with the application, objects to provide the GUI, e.g., images, text, icons, buttons, etc., user information, documents, databases, or associated data.

The storage 160 may be implemented as a memory card such as micro secure digital (SD) card, a universal serial bus (USB) memory, or the like, a non-volatile memory, a volatile memory, a hard disc drive (HDD), or a solid state drive (SSD).

When the display device 100 is implemented as an interactive board, the storage 160 may store a computer program to perform the interactive board function when executed under control of the controller 140. To provide a screen to perform the interactive board function, the program stored in the storage 160 may be executed by a processor such as the controller 140. The program to perform the interactive board may be stored at a design stage of the display device 100, and updated in the form of firmware. Such updating in the form of firmware may be performed by wired or wireless communication through the communicator 150.

The controller 140 may control general operations of the display device 100. The controller 140 may be implemented as a microprocessor with a memory for storing an algorithm to control operation of the components of the display device 100 or data about a program that embodies the algorithm, and a processor for carrying out the aforementioned operation using the data stored in the memory. The memory and the processor may be implemented in separate chips. Alternatively, the memory and the processor may be implemented in a single chip.

The controller 140 may access the storage 160 to execute an operating system (OS) stored in the storage 160 for providing general operations of the display device 100. The controller 140 accesses various programs, contents, data, etc., stored in the storage 160 to perform various operations of the display device 100.

The controller 140 may determine whether to output a sound signal corresponding to an image of at least one area based on a state of the image, based on a command from the user.

The image of the at least one area may refer to images output in windows on the display 110. Furthermore, the image of the at least one area may be an image output from each application, or an image output from each external device, which will be described later. The at least one area may be displayed as including a visibly displayed boundary.

The state of an image may include ‘activated’ and ‘deactivated’. An activated image may include that the user determines to watch the image. For example, when an image of at least one area is output with higher priority than others, or when the image is output in full screen, the user controls the image or an application including the image.

A deactivated image may include that the user does not watch the image. However, deactivating an image does not mean turning off the image completely, but maintaining the image ready to be activated at any time according to a command from the user.

For example, an image may be deactivated e.g., when the image is minimized, when the user selects an area other than the area of the image to run an application other than the application corresponding to the image, when the user eliminates the image but generates the image in the background, when the user gives second priority to the image in many different ways, etc.

The controller 140 may control output of a sound signal corresponding to an image of at least one area to be stopped by deactivating the image of the at least one area output on the display 110, based on a command from the user.

Deactivating an image of at least one area may be based on an operation of the user changing priority, a command from the user to minimize the image, and a command from the user to select an area on the display other than the at least one area.

An image of at least one area output on the display 110 may be images resulting from a plurality of applications output on the display device 100. In this case, the controller 140 may control output of a sound signal from an application to be stopped by deactivating the image output from the application.

An image of at least one area reproduced on the display 110 may be an image of a screen provided by an external device connected to the display device 100. In this case, when the image of the at least one area is deactivated, the controller 140 may control the display 110 not to output the sound signal received from the external device.

Furthermore, the controller 140 may control creation or output of a sound signal in the external device to be stopped by sending a control signal to stop the sound signal to the external device. In this case, the control signal may be different depending on the external device. Specifically, the controller 140 may create a control signal based on a kind of the OS executed by the external device. This will be described later in detail.

The controller 140 may activate output of a sound signal of an external device, which corresponds to an image selected from among images of the plurality of external devices, and stop outputting sound signals of the other external devices corresponding to non-selected images. The display device 100 may be connected to the plurality of external devices and may simultaneously output the plurality of images output from the external devices. The user may select one of the plurality of images through the input 130 to output a sound signal corresponding to the selected image.

At this time, the controller 140 may stop outputting sound signals corresponding to other images or may reduce volume of such sound signals to be inaudible. Therefore, audio interference between competing sound signals may be avoided.

The controller 140 may stop outputting the sound signal by omitting the image from the display 110. Stopping output of a sound signal by omitting an image may be similar to an operation of stopping the sound signal by minimizing the image. Alternatively, sound may be stopped when a corresponding image is closed or a connection to the external device providing the image is suspended or terminated.

Furthermore, the controller 140 may release suspension of the sound signal by activating the deactivated image of at least one area. Specifically, the controller 140 may quickly activate or deactivate an image based on a command from the user, and accordingly activate or deactivate a sound signal corresponding to the image.

For example, an occasion is assumed when the display device 100 is implemented as an interactive board and the display 110 displays a screen that provides interactive board functions. In this case, the controller 140 may execute an interactive board function displayed at the coordinates of a detected touch point. The interactive board function may include a writing (input) function, an editing function, a video play function, a function for storing a screen on which a writing is input, etc.

The writing function may be performed based on an input of the user's touch or an electronic pen, and the controller 140 may execute a function or application corresponding to the input.

The editing function may include e.g., deleting, correcting or copying input text, or changing font size, font type, color, writing style, etc., and may include other commonly-used document editing functions.

The video play function refers to a function to reproduce moving images, still images, etc., on the interactive board.

The interactive board functions may not, however, be limited thereto, and may include all the other functions usable by the interactive board.

At least one component may be added or omitted to correspond to the performance of the components of the display device 100 shown in FIG. 100. Furthermore, as understood to those of ordinary skill in the art, the components of the display device 100 may be changed to correspond to the system performance or structure.

The functions of the components of the display device 100 shown in FIG. 2 may be implemented in software, or hardware such as Field Programmable Gate Arrays (FPGAs) and Application Specific Integrated Circuits (ASICs).

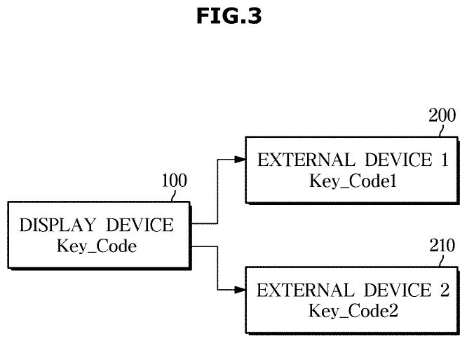

FIG. 3 shows a relationship between a display device and external devices 200 and 210, according to an embodiment of the disclosure.

Referring to FIG. 3, the display device 100 may be connected to at least one external device to communicate with the external device 200, 210.

The display device 100 may communicate with the at least one external device 200 and 210. The display device 100 may communicate with the external device directly or over one or more networks.

In an embodiment of the disclosure, the network may include a local area network (LAN). The display device 100 may receive a signal from the external device 200 or 210 and display an image output from the external device. Receiving a signal from the external device 200 or 210 at the display device 100 may be performed by the user through remote control. In an embodiment of the disclosure, the user of the display device 100 may remotely control an external device to reproduce multimedia content of the external device.

In an embodiment of the disclosure, the display device 100 may determine a state of remote control operation and accordingly transmit a particular control signal to the external device 200 or 210.

Specifically, the control signal transmitted by the display device 100 to the external device 200 or 210 may include at least one key code.

The key code transmitted by the display device 100 may be created or changed based on the operating system (OS) executed by each of the display device 100 and the external devices 100 and 210.

For example, the windows OS may use a virtual key code (VK) scheme, the Linux OS an x key code (XK) scheme or xfree86 key code (XF86) scheme, and the Mac OS an Apple VK scheme.

When the display device 100 transmits a control signal to the external device 200 or 210, the display device 10 may modify and transmit the control signal usable by the external device 200 or 210. The display device 100 may change the key code included in the control signal based on the OS executed by the external device. In an embodiment of the disclosure, the key codes VK, XK, XF86, and Apple VK may be interchangeably used. In an embodiment of the disclosure, when the display device 100 may operate in the Linux OS, the controller 140 of the display device 100 may create the control signal with the XK code and change the control signal to one including VK, XF86, or Apple VK code based on the OS of the external device.

The display device 100 may create a control signal to control the external device 200 or 210 and transmit the control signal to the external device 200 or 210.

In an embodiment of the disclosure, the display device 100 may transmit a control signal to the external device 200 or 210, which includes a key code to instruct the external device 200, 210 to stop outputting sound of the external device 200 or 210. Specifically, the external device 200 or 210 may include a sound output controller for controlling sound output, which may stop outputting and/or transmission of a sound signal of the external device upon reception of the control signal from the display device 100.

The configuration of FIG. 3 is merely an example, and there are no limitations on how the display device 100 may control suspension of a sound signal of the external device.

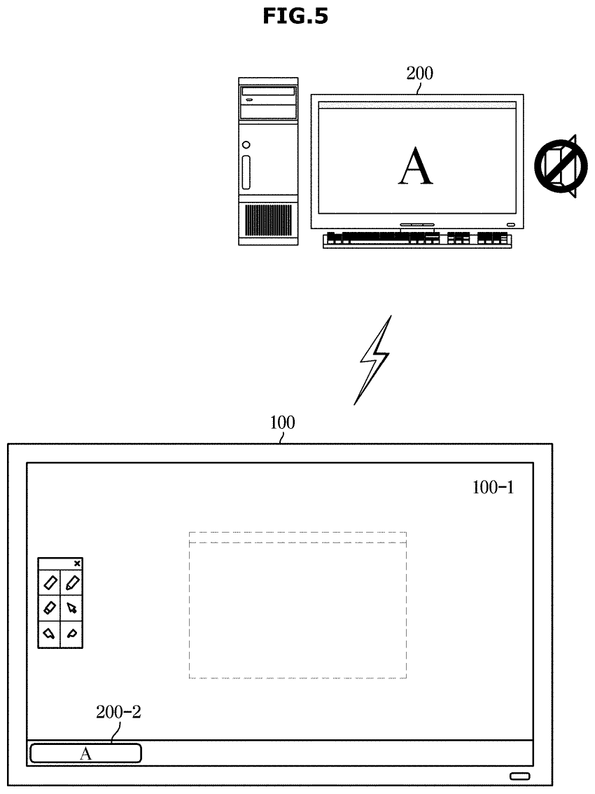

FIG. 4 shows outputting a sound signal corresponding to an image of at least one area, according to an embodiment of the disclosure, and FIG. 5 is a diagram for explaining an operation to stop outputting sound based on an image minimization command, according to an embodiment of the disclosure.

Referring to FIG. 4, as described above, the display device 100 may communicate with at least one external device 200. The display device 100 may be connected to the external device 200 directly or over a network. The display device 100 may remotely control the external device 200.

In an embodiment of the disclosure, the user may remotely control the external device 200 through the display device 100 to have an image 200-1 or sound output by the external device 200 to be reproduced through a screen 100-1 of the display device 100 or to stop outputting the image 200-1 or the sound. In other words, the user may enter a signal to reproduce an image output by the external device 200, on the display device 100, or to stop reproducing the image on the display device 100.

Furthermore, the display device 100 may output or stop outputting a sound signal provided from the external device 200, at the display device 100. In an embodiment of the disclosure, the user may enter a command to silence, stop, suspend, or otherwise make inaudible the sound of the external device 200 through the display device 100.

FIG. 5 is a diagram for explaining an operation to stop outputting sound based on an image minimization command, according to an embodiment of the disclosure.

Referring to FIG. 5, an image of the external device 200 that has been displayed in the display device 100 is minimized 200-2. Minimizing 200-2 an image of the external device 200 may be performed through the input 130, or through at least one button equipped in the display device 100.

The operation of minimizing 200-2 an image of the external device 200 at the display device 100 may include activating and deactivating a remote control function.

In this case, deactivation refers to minimization that maintains the function ready to be activated at any time based on another command from the user. When the image provided by the external device 200 is minimized 200-2, the reproduction of the image provided by the display device 100 is suspended or otherwise obscured from a user of the display device 100.

When the image of the external device 200 is minimized 200-2 at the display device 100, the controller 140 may transmit a signal to control a sound signal of the external device 200 based on the state of the image of the external device 200. Specifically, when the image of the external device 200 is minimized, the controller 140 may transmit a control signal including a key code to silence the sound signal of the external device 200 to the external device 200. Based on the key code transmitted from the display device 100, the external device 200 may stop outputting the sound signal and/or transmitting the sound signal.

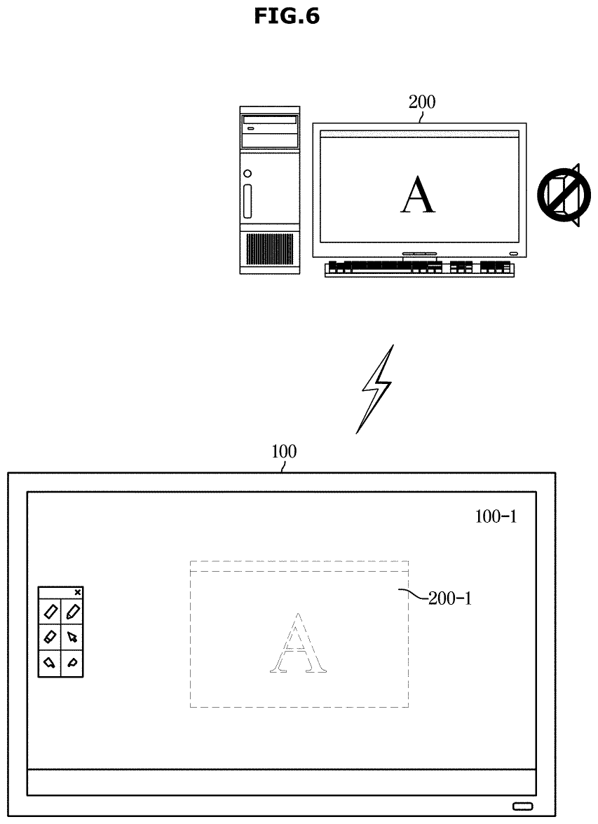

FIG. 6 is a diagram for explaining an operation to stop outputting sound by removing an image, according to an embodiment of the disclosure.

Referring to FIG. 6, an image of the external device 200 that has been displayed at the display device 100 is removed 200-1. Removing 200-1 an image of the external device 200 may be performed through the input 130, or through at least one button equipped in the display device 100. The removing 200-1 of an image from the display device 100 may include stopping execution of an application corresponding to the image, but maintaining general execution of the application to be activated at any time based on a command from the user.

The removal 200-1 of an image from the display device 100 may also be based on activating and deactivating the remote control function.

In this case, deactivation refers to minimization that maintains the function ready to be activated at any time based on another command from the user.

When the image of the external device 200 is removed from display of the display device 100, the controller 140 may transmit a signal to control a sound signal of the external device 200 based on the state of the image of the external device 200. Specifically, when the image of the external device 200 is removed from the display device 100, the controller 140 may transmit a control signal including a key code to silence the sound signal of the external device 200 to the external device 200. Based on the key code transmitted from the display device 100, the external device 200 may stop outputting the sound signal.

FIGS. 5 and 6 are examples of deactivating an image output by the display device, and there are no limitations on how to deactivate the image.

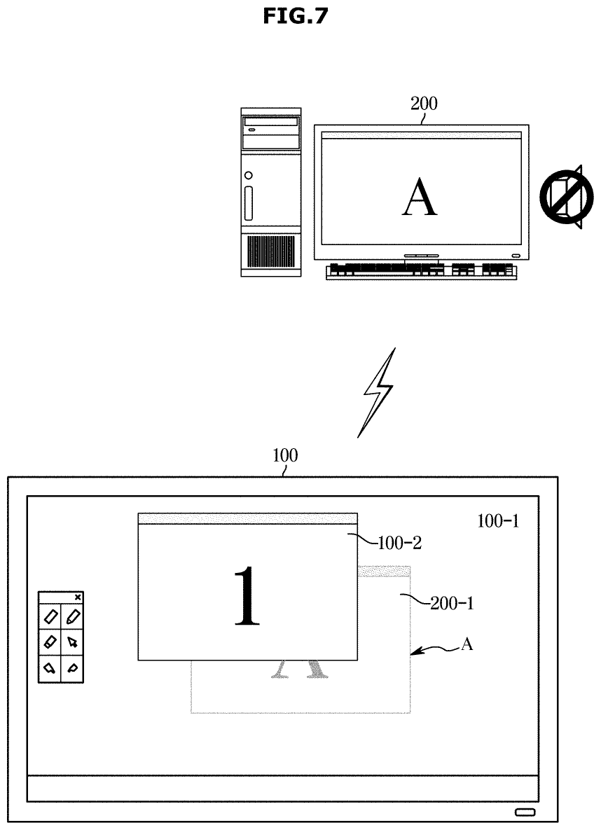

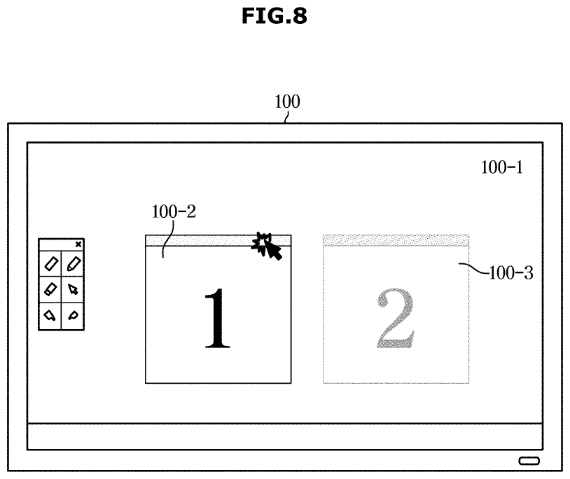

FIGS. 7 and 8 are diagrams for explaining an operation to set priorities among applications, according to an embodiment of the disclosure.

Referring to FIG. 7, images 100-2 and 200-1 correspond to an application executed by the display device 100 itself and an application executed by an external device 200, respectively, are shown on the screen 100-1 of the display device 100. The user may execute the application at the display device 100 itself, and simultaneously control the image 200-1 of the external device to be provided by remote control. The user may control output of a sound signal corresponding to an image driven at the display device 100 or output of a sound signal corresponding to the image 200-1 of the external device, based on a selection of the user according to user input through the input 130.

In this case, the user may set a priority for each image. In an embodiment of the disclosure, the user may assign top priority to an image the user wants to watch by placing the image 100-2 on the top layer of the screen 100-1. The display device 100 may output a sound signal corresponding to the image given top priority by the user. In FIG. 7, the image 100-2 originated from the display device 100 has the top priority and the image 200-1 originated from the external device 200 has a lower priority. In this case, the display device 100 may output a sound signal corresponding to the image 100-2 originated from the display device 100, while not providing the sound of the external device 200 based on the aforementioned operations.

On the other hand, the user may assign the top priority to the image originated from the external device 200, in which case the display device 100 may not provide the sound signal of the application running at the display device 100, and instead provide sound of the application executed by the external device 200.

Referring to FIG. 8, an operation of setting mutual priority between applications running at the display device 100 will be described. The controller 114 of the display device 100 may execute a plurality of applications 100-2 and 100-3, at the display device 100. When at least one of the plurality of applications outputs sound via the display device 100, the user may set a top priority to one of the plurality of applications, e.g., 100-2, to control the sound of the application given the top priority to be output through the display device 100. The top priority may be given for an application by placing the application on the top layer on the display device 100 as shown in FIG. 7, or by a selection that reflects intention of the user as shown in FIG. 8. For example, in the display device 100, a first application and a second application may run at the same time.

When the user selects the first application, e.g., 100-2, with the top priority by selection through the input 130, the controller 114 may control the sound of the first application to be output through the display device 100 while controlling the sound of the second application, e.g., 100-3, to not be provided by the display device 100. Selecting the application by the user may be included in the operation of activating the application.

Furthermore, the user may silence the sound of the image 100-2, 100-3 by selecting an area 100-1 other than the plurality of application areas 100-2 and 100-3. Selecting the area 100-1 other than the area of an image may indicate that the user has little intention to watch the either image, so the sound corresponding to both images 100-2, 100-3 may not be provided.

Although an application is selected to be activated in FIGS. 7 and 8, activation of applications is not limited thereto.

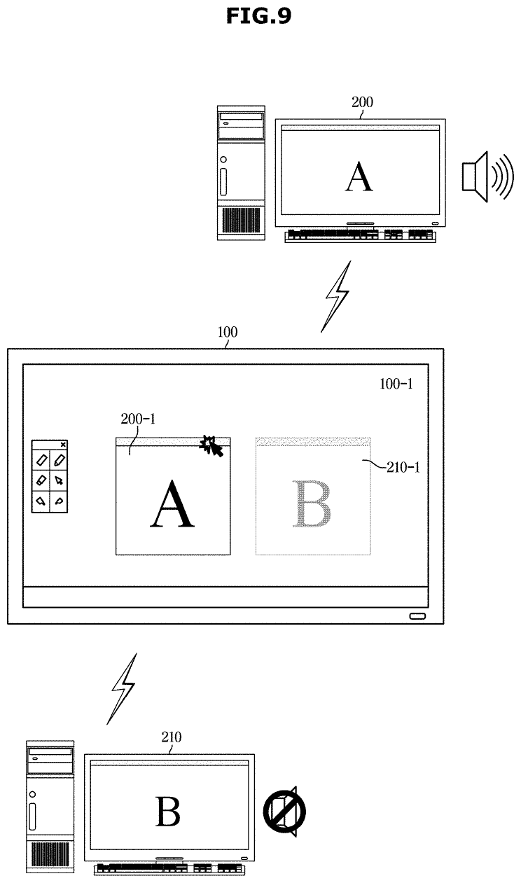

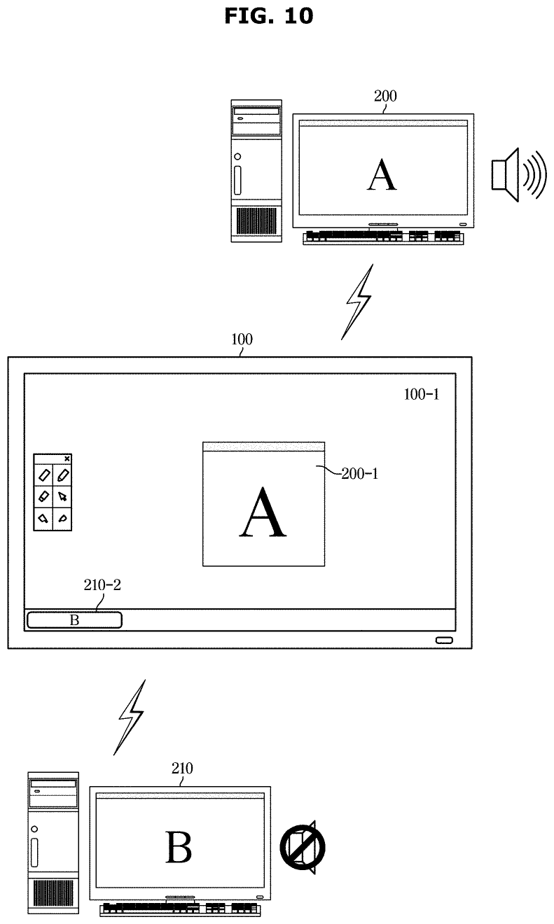

FIGS. 9 and 10 are diagrams for explaining an operation performed when a display device is connected to a plurality of external devices, according to an embodiment of the disclosure.

Referring to FIGS. 9 and 10, the display device 100 communicates with the plurality of external devices 200 and 210. The plurality of external devices 200 and 210 may include the first external device 200 and the second external device 210. Although there are two external devices shown in FIGS. 9 and 10, the number of external devices is merely an example and there are no limitations on the number of external devices that may be connected to the display device 100. Furthermore, the terms ‘first’ and ‘second’ used for the external devices are to distinguish one external device from another without meaning to assign priority.

Referring to FIG. 9, the display device 100 may output images 200-1 and 200-2 originated from both the first and second external devices 200 and 210.

The user may activate sound output from the external device 200 corresponding to the image 200-1 by selecting the image 200-1 of the external device 200. At the same time, the controller 114 of the display device 100 may stop the external device 210 from outputting sound signals corresponding to the image 210-1 not selected.

How the user selects an image originated from an external device may be embodied as shown in FIG. 9. Specifically, when the user selects the image 200-1 originated from the first external device 200 at the display device 100, the display device 100 may transmit a control signal to control sound output to the first external device 200. The display device 100 may transmit another control signal to stop sound output to the unselected second external device 210.

The display device 100 may output the sound corresponding to the first external device 200 and withhold outputting of the sound corresponding to the second external device 210.

While the display device 100 outputs the sound signal of the first external device 200 that corresponds to an image that the user wants to activate and suspends outputting the sound signal of the second external device 200 not selected as shown in FIG. 9, the sound output may be stopped by selection, as will be described later.

Referring to FIG. 10, the display device 100 may be connected to the first external device 200 and the second external device 210 as in FIG. 9. The user may minimize an image 200-1, 210-1 corresponding to the first external device 200 or second external device 210. In FIG. 10, the user minimizes an image 210-2 corresponding to the second external device 210. The display device 100 may stop outputting a sound signal from the second external device 210 corresponding to the minimized image 210-2. Specifically, the display device 100 may transmit a control signal to stop outputting the sound from the second external device 210. As described above, the control signal transmitted by the display device 100 may include a corresponding key code. Furthermore, when the display device 100 is connected to a plurality of external devices, the control signal for transmission may be changed based on the OS used by the connected external device. Transmission of a control signal based on the OS was described above, so the description thereof will not be repeated.

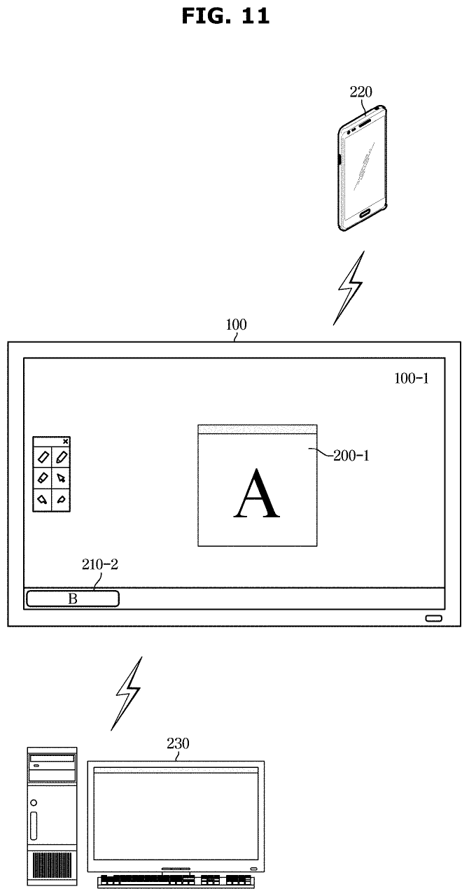

FIG. 11 is a diagram for explaining a display device performing an authentication procedure and controlling external devices 220 and 230, according to an embodiment of the disclosure.

The controller 114 may communicate with at least one external device 220 and 230 after performing a predefined authentication and/or pairing procedure with the external device based on a command from the user.

In general, the authentication procedure may refer to a process for a device to identify unique information of another device before the device is connected to the other device to control the other device.

In general, during an authentication procedure, the external device 220 or 230 may request a name, identity (ID), and password of the user or the display device 100.

In the embodiments of the disclosure, the display device 100 may have an application related to the authentication procedure installed thereon in advance.

The external device 220 or 230 may also have an application installed to correspond to the application installed in the display device 100. The applications installed in the display device 100 and the external device 220 or 230 may automatically perform a predefined authentication procedure. This may allow the user to perform the authentication procedure without entering an extra password when the user is to control the external device 220 or 230 through the display device 100.

The aforementioned authentication procedure is merely an example of a predefined authentication procedure, without being limited thereto.

The controller 114 may create a signal to control the at least one external device through the display device 100 based on a command from the user.

Specifically, the controller 114 may convert an input from the user to a control signal that an OS protocol supported by each of the at least one external device 220 or 230.

The controller 114 may send the control signal to the external device over a network connected to the display device 100 and the external device 220 or 230.

Accordingly, the controller 114 of the display device 100 may control a remote device based on each control signal.

For example, when the user enters a command to deactivate an image of at least one area, the controller 114 may create a control signal corresponding to the OS (e.g., Windows®, Linux®, IOs®, Android®, etc.) of each external device 220 or 230 based on the command.

Specifically, the controller 114 may convert the command into a key code related to audio silence among virtual keyboard key codes used in the protocol of each external device, e.g., rdp, vnc, etc. The controller 114 may send the key code to the external device over the network. After the external device receives the key code, sound signals of the external device may be remotely controlled.

The operation as described above in connection with FIG. 11 is merely an example, and there are no limitations on how the user controls the external device through the display device 100.

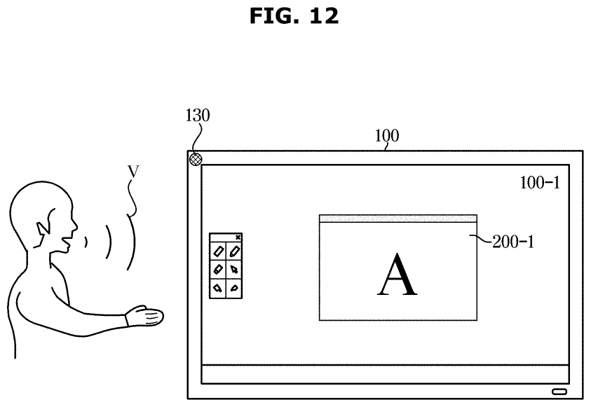

FIG. 12 is a diagram for explaining a display device performing an operation based on a voice command.

Referring to FIG. 12, the user's command may include a voice command V as user input.

The controller 114 may create a control signal to control at least one of the display device 100 and the at least one external device based on the voice command V.

Specifically, when the user enters the voice command V, the controller 114 may convert the voice command to a command used in the protocol of an OS of each external device.

In this case, the input 130 may include a microphone.

For example, the user may enter a command by saying “turn down the sound” through the microphone.

The controller 114 may include a voice recognition application.

The controller 114 may convert the user's voice command to a key code related to an audio process among the virtual keyboard key codes used in the protocol of each external device.

The controller 114 may send the key code to the external device over the network, and after the external device receives the key code, an audio function of the external device may be controlled. In this embodiment, an external device is controlled based on the voice command, but in some other embodiments, the display device 100 may also be controlled based on the voice command.

The operation as described in connection with FIG. 12 is merely an example, and there are no limitations on how the user controls the display device or the external device based on the voice command.

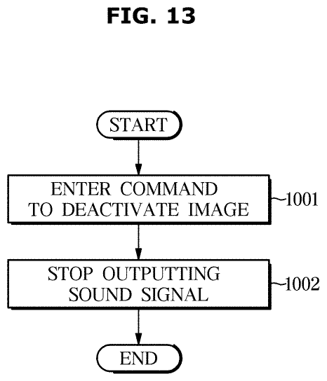

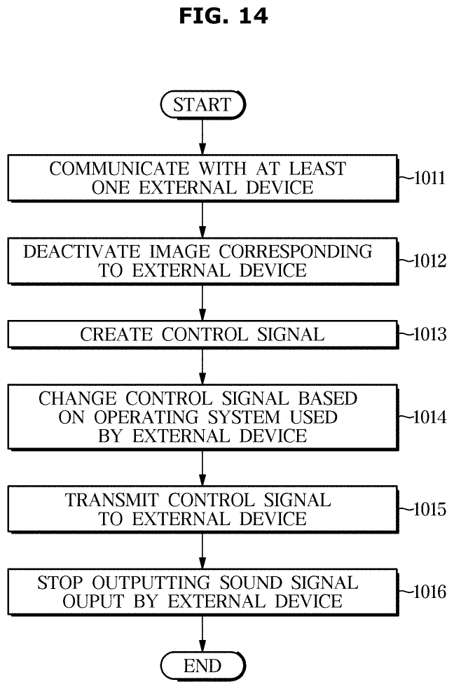

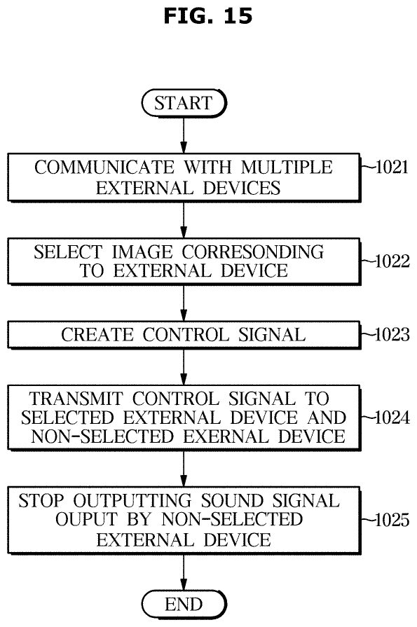

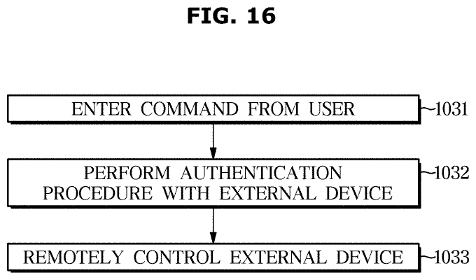

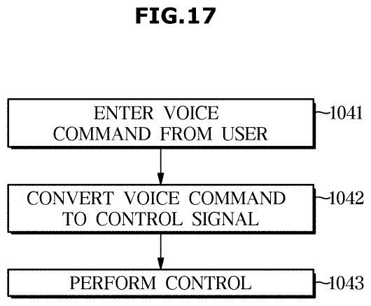

FIG. 13 is a flowchart of a method of controlling a display apparatus, according to an embodiment of the disclosure, FIG. 14 is a flowchart of a method of controlling a display apparatus, according to an embodiment of the disclosure, FIG. 15 is a flowchart of a method of controlling a display apparatus, according to an embodiment of the disclosure, FIG. 16 is a flowchart of a method of controlling a display apparatus, according to an embodiment of the disclosure, and FIG. 17 is a flowchart of a method of controlling a display apparatus, according to an embodiment of the disclosure.

Referring to FIG. 13, the user enters a command to deactivate an image through the input 130 of the display device 100, in 1001. The controller 114 stops outputting a sound signal corresponding to the image, in 1002, in response to the command.

Referring to FIG. 14, an occasion of remote control through the display device 100 is described. The display device 100 communicates with at least one external device, in 1011. The display device 100 deactivates an image corresponding to the external device based on a command from the user, in 1012. The deactivation of the image may include minimizing the image. The display device 100 creates a control signal corresponding to the deactivation of the image, in 1013. The control signal may include a key code. The display device 100 modifies the control signal based on an OS used by the external device, in 1014. The modified control signal is transmitted to the external device, in 1015. When receiving the control signal, the external device stops outputting a sound signal based on the control signal, in 1016.

FIG. 15 is a flowchart of a method when the display device 100 communicates with a plurality of external devices.

The display device 100 communicates with a plurality of external devices, in 1021. The user of the display device 100 selects an image corresponding to an external device, in 1022. The display device 100 may activate and output a sound signal corresponding to the selected image and deactivate and stop outputting a sound signal corresponding to an unselected image. To execute this control, the display device 100 creates corresponding control signals, in 1023, and transmits the control signals to the devices selected and not selected based on the selected image, in 1024. An external device corresponding to the unselected image receives the control signal to stop outputting the sound, in 1025, and ceases to output the sound.

Referring to FIG. 16, the user enters a command, in 1031. Based on the command from the user, the display device 100 performs an authentication procedure with an external device, 1032. After completion of the authentication procedure between the display device 100 and the external device, the user remotely controls the external device through the display device 100, in 1033.

Referring to FIG. 17, the user enters a voice command, in 1041. The display device 100 converts the voice command into a control signal, in 1042. The display device 100 controls the display device 100 itself or the external device based on the control command, in 1043.

The embodiments of the disclosure may be implemented in the form of recording media for storing instructions of computer programs to be executed by a computer. The computer-readable instructions may be stored in the form of program codes, and when executed by a processor, may constitute program modules to perform operations in the embodiments of the disclosure. The recording media may correspond to computer-readable recording media.

The computer-readable recording medium includes any type of recording medium having data stored thereon that may be thereafter read by a computer. For example, the computer-readable recording medium may be a ROM, a RAM, a magnetic tape, a magnetic disk, a flash memory, an optical data storage device, etc.

According to an embodiment of the disclosure, a display device and control method thereof may control output of a sound signal corresponding to an image by controlling image output without an extra control operation.

Several embodiments have been described above, but a person of ordinary skill in the art will understand and appreciate that various modifications can be made without departing the scope of the disclosure. Thus, it will be apparent to those ordinary skilled in the art that the true scope of technical protection is only defined by the following claims.

What is claimed is:

1. A display device comprising:
a communication interface configured to receive, from an external device, video data of video information displayed on the external device and audio data corresponding to the video data;
a speaker;
a display;
an input interface configured to receive user input of a user of the display device; and
a controller configured to:
control the display to display the video information, based on the video data,
control the speaker to output audio, based on the audio data,
control the input interface to receive the user input to deactivate displaying of the video information, and
control the speaker to suspend the audio, based on the user input to deactivate the displaying of the video information.

2. The display device of claim 1, wherein the controller is further configured to, when the input interface receives the user input to deactivate the displaying of the video information, control the speaker to stop the audio.

3. The display device of claim 1, wherein the controller is further configured to determine whether to output the audio corresponding to the video data based on a state of the video information based on the user input of the user.

4. The display device of claim 1, wherein the controller is further configured to determine whether to output the audio by transmitting at least one control signal based on the user input to deactivate the displaying of the video information to the external device.

5. The display device of claim 1, wherein the controller is further configured to generate at least one control signal based on an operating system used by the external device.

6. The display device of claim 1, wherein the user input to deactivate the displaying of the video information comprises a user input to display second video information of second video data received from a second external device, and
wherein the controller is further configured to control the speaker to output second audio corresponding to the second video data, based on the user input to display the second video information and stop outputting of the audio based on the audio data received from the external device.

7. The display device of claim 1, wherein the user input to deactivate the displaying of the video information comprises a command to change display priority of the video information received from the external device, and
wherein the controller is further configured to control the speaker to suspend the audio, based on the priority of the video information.

8. The display device of claim 1, wherein the user input to deactivate the displaying of the video information comprises a command to select a second area on the display other than a first area on which the video information is displayed, and
wherein the controller is further configured to control the speaker to suspend the audio, based on the command to select the second area on the display.

9. The display device of claim 1, wherein the user input to deactivate the displaying of the video information comprises a command to minimize an area on which the video information is displayed, and
wherein the controller is further configured to control the speaker to suspend the audio, based on the command to minimize the area.

10. The display device of claim 1, wherein the user input to deactivate the displaying of the video information comprises a command to remove the video information from the display, and
wherein the controller is further configured to control the speaker to suspend the audio based on the command to remove the video information from the display.

11. The display device of claim 1, wherein the controller is further configured to control the input interface to receive user input to activate displaying of the video information and control the speaker to release suspension of the audio based on the user input to activate the displaying of the video information.

12. The display device of claim 1, wherein the controller is further configured to communicate with the external device after performing a predefined authentication procedure with the external device.

13. The display device of claim 12, wherein the controller is configured to create a control signal to control the external device through the display device.

14. The display device of claim 1, wherein the user input comprises a voice command.

15. A method of controlling a display device, the method comprising:
receiving, from an external device, video data of video information displayed on the external device and audio data corresponding to the video data;
controlling a display of the display device to display the video information, based on the video data;
controlling a speaker of the display device to output audio, based on the audio data;
receiving user input to deactivate displaying of the video information; and
controlling the speaker to suspend the audio, based on the user input to deactivate the displaying of the video information.

16. The method of claim 15, wherein the controlling the speaker to suspend the audio comprises controlling the speaker to suspend the audio when the user input to deactivate the displaying of the video information is received.

17. The method of claim 15, wherein the controlling the speaker to suspend the audio comprises:
determining whether to output the audio corresponding to the video data based on a state of the video information based on the user input.

18. The method of claim 15, wherein the controlling the speaker to suspend the audio comprises:
determining whether to output the audio by transmitting at least one control signal based on the user input to deactivate the displaying of the video information to the external device.

19. The method of claim 15, wherein the controlling the speaker to suspend the audio comprises:
generating at least one control signal based on an operating system used by the external device.

20. The method of claim 15, wherein the user input to deactivate the displaying of the video information comprises a user input to display second video information of second video data received from a second external device, and
wherein the method further comprises:
controlling the speaker to output second audio corresponding to the second video data, based on the user input to display the second video information; and
stopping outputting of the audio based on the audio data received from the external device.

21. The method of claim 15, wherein the user input to deactivate the displaying of the video information comprises a command to change display priority of the video information received from the external device, and
wherein the controlling the speaker to suspend the audio comprises controlling the speaker to suspend the audio, based on the priority of the video information.

22. The method of claim 15, wherein the user input to deactivate the displaying of the video information comprises a command to select a second area on the display other than a first area on which the video information is displayed, and
wherein the controlling the speaker to suspend the audio comprises controlling the speaker to suspend the audio, based on the command to select the second area on the display.

23. The method of claim 15, wherein the user input to deactivate the displaying of the video information comprises a command to minimize an area on which the video information is displayed, and
wherein the controlling the speaker to suspend the audio comprises controlling the speaker to suspend the audio, based on the command to minimize the area.

24. The method of claim 15, wherein the user input to deactivate the displaying of the video information comprises a command to remove the video information from the display, and
wherein the controlling the speaker to suspend the audio comprises controlling the speaker to suspend the audio based on the command to remove the video information from the display.

25. The method of claim 15, further comprising:
receiving user input to activate displaying of the video information; and
releasing suspension of the audio based on the user input to activate the displaying of the video information.

26. The method of claim 15, wherein receiving comprises communicating with the external device after performing a predefined authentication procedure with the external device.

27. The method of claim 26, further comprising:
creating a control signal to control the external device through the display device.

28. The method of claim 15, wherein the user input comprises a voice command.
